(19) United States
(12) Patent Application Publication
(10) Pub. No.: US 2012/0023964 A1
(43) Pub. Date: Feb. 2, 2012

(54) LIQUID-FUELED PREMIXED REVERSE-FLOW ANNULAR COMBUSTOR FOR A GAS TURBINE ENGINE

(76) Inventor: Carsten Ralf Mehring, Ladera Ranch, CA (US)

(21) Appl. No.: 12/844,082

(22) Filed: Jul. 27, 2010

(51) Int. Cl. F02C 7/22

(52) U.S. Cl. 60/776; 60/737; 60/740

(57) ABSTRACT

A reverse flow annular combustor for a gas turbine includes a pre-vaporizer/pre-mixing region within a dome section, a liquid fuel injection system feeding the pre-mixing region, a combustion region downstream of the pre-vaporizer/pre-mixing region, a means for guaranteeing stable and sustained combustion in the combustion region, and a dilution region downstream of the combustion region.

### STATEMENT REGARDING FEDERALLY SPONSORED RESEARCH OR DEVELOPMENT

This disclosure was made with Government support under N00019-06-C-0081 awarded by The United States Navy. The Government has certain rights in this disclosure.

### BACKGROUND

The present disclosure relates to a gas turbine engine and more particularly to a reverse flow annular combustor for an auxiliary power unit (APU).

An APU is often utilized to supplement main propulsion engines to provide electrical and/or pneumatic power as well as start the main propulsion engines. APUs are typically a radial or axial gas turbine engine having a compressor, a combustor, and a turbine. The combustor is often a liquid-fueled non-premixed reverse flow annular combustor with an active dome primary combustion zone using liquid fuel injectors to direct a fuel spray into a liner dome section to form a combustible mixture with the air admitted to the dome.

### SUMMARY

A reverse flow annular combustor for a gas turbine engine according to an exemplary aspect of the present disclosure includes a pre-vaporizer/pre-mixing region within a dome section, liquid fuel injectors admitting a fuel spray to that dome section, a combustion region downstream of the pre-vaporizer/pre-mixing region and a dilution region downstream of the combustion region.

A method of combustion within a reverse flow annular combustor for a gas turbine engine according to an exemplary aspect of the present disclosure includes: injecting liquid fuel into a liner dome section forming a pre-vaporizer/pre-mixing region within a liner dome section; forming a combustion region downstream of the pre-vaporizer/pre-mixing region; and forming a dilution region downstream of the combustion region.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a partial phantom view of a rotary-wing aircraft illustrating a power plant system;

FIG. 2 is a general sectional view of an auxiliary power unit;

FIG. 3 is an expanded schematic sectional view of a combustor for the auxiliary power unit falling within the embodiment of the present invention;

FIG. 4 is an expanded schematic sectional view of a RELATED ART combustor;

FIG. 5A is a sectional view of a combustor according to one non-limiting embodiment of the present application without the effusion holes shown; and

FIG. 5B is a rear view of the combustor of FIG. 5A.

### DETAILED DESCRIPTION

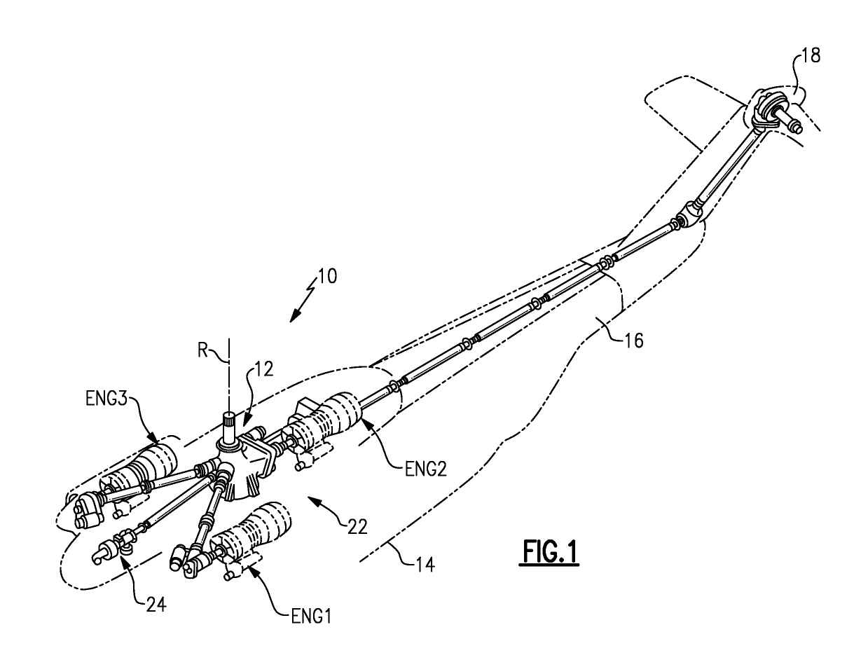

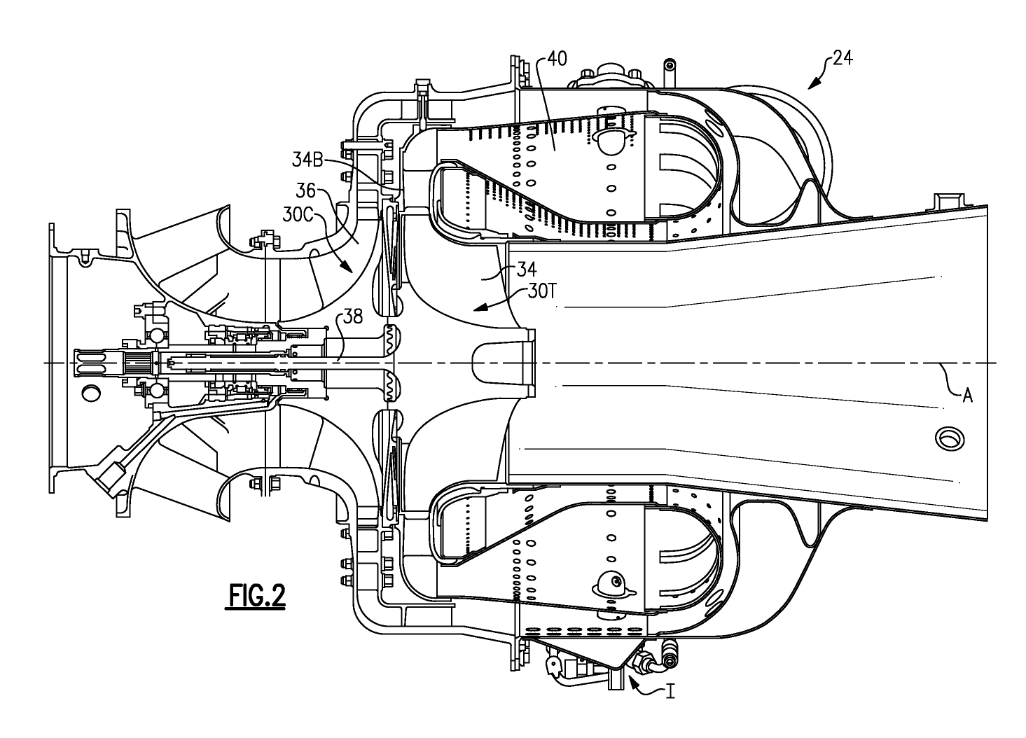

FIG. 1 schematically illustrates a rotary-wing aircraft 10 having a main rotor system 12. The aircraft 10 includes an airframe 14 having an extending tail 16 which mounts an anti-torque system 18. The main rotor system 12 is driven about an axis of rotation R through a main rotor gearbox (MGB) 20 by a multi-engine powerplant system 22—here having three engine packages ENG1, ENG2, ENG3 as well as an Auxiliary Power Unit (APU) 24 (FIG. 2). The multi-engine powerplant system 22 generates the power available for flight operations and couples such power to the main rotor assembly 12 through the MGB 20. Although a particular helicopter configuration is illustrated and described in the disclosed embodiment, other configurations and/or machines, such as high speed compound rotary-wing aircraft with supplemental translational thrust systems, dual contra-rotating, coaxial rotor system aircraft, turbo-props, tilt-rotor, fixed wing aircraft and non-aircraft applications such as ground vehicles will also benefit herefrom.

Referring to FIG. 2, the APU 24 in the disclosed non-limiting embodiment is a radial gas turbine engine having a turbine wheel 30T that defines a plurality of turbine blades 34 is disposed opposite a compressor wheel 30C that defines a plurality of compressor blades 36 about an axis of rotation A. A shaft 38 extends from the turbine wheel 30T and through the compressor wheel 30C such that the turbine wheel 30T and compressor wheel 30C are coaxially coupled. The compressor blades 36 compress air for communication to a combustor 40 and the turbine blades 34 convert pressure energy of exhaust gases from the combustor 40 into rotational energy. The turbine blades 34 are shaped such that high pressure combusted gases impinge thereon to drive the shaft 38 to thereby convert heat and pressure into mechanical energy. In a similar axial gas turbine engine, the combustion air also exits the combustor radially inwards but is turned axially towards the engine AFT end before entering the axial turbine wheel.

With reference to FIG. 3, the combustor 40 includes a staged-combustion reverse flow annular combustor design for a radial gas turbine engine. The combustor 40 includes a system of circumferentially spaced liquid fuel injector system (illustrated schematically at I) fueling a pre-vaporizer/pre-mixing region 42; a pre-vaporizer/pre-mixing region 42 within a dome section 44 followed by a narrowly controlled combustion region 46 and a downstream dilution region 48, thereafter having a relatively tight turn 50 into the radially oriented turbine nozzle 34B and turbine blades 34.

The cross sectional layout of the reverse flow annular combustor 40 follows a typical non-premixed combustor design such as a Rich-Quench-Lean (RQL) combustor, such as proposed within the HSPS/PWA Pyrospin™ RQL Combustor. In the disclosed non-limiting embodiment, the selected fuel injection configuration, size selection and location of OD and ID primary 46J/dilution 47/film 43/dome jets 42J is such that the liner dome section 44 of the combustor 40 is primarily used for fuel preparation, i.e., atomization, vaporization and mixing while stable combustion is effectively achieved in the relatively short combustion region 46 downstream of the pre-vaporizer/pre-mixing region 42, i.e., downstream of the OD and ID primary cross-flow air jets 46J, but before the dilution region 48 and dilution jets 47. It should be understood that the combustion region 46 may be augmented by, for example, Pyrospin technology, i.e., effusion jet enhanced mixing as indicated by the effusion jets 48 IJ in FIG. 3. Flame stabilization in region 46 can be achieved by a properly designed injector body acting (besides its primary function as fuel injector) as material flame holder or by fluidic flame holders given by the cross flow jets 46J emanating from the primary OD and ID holes.

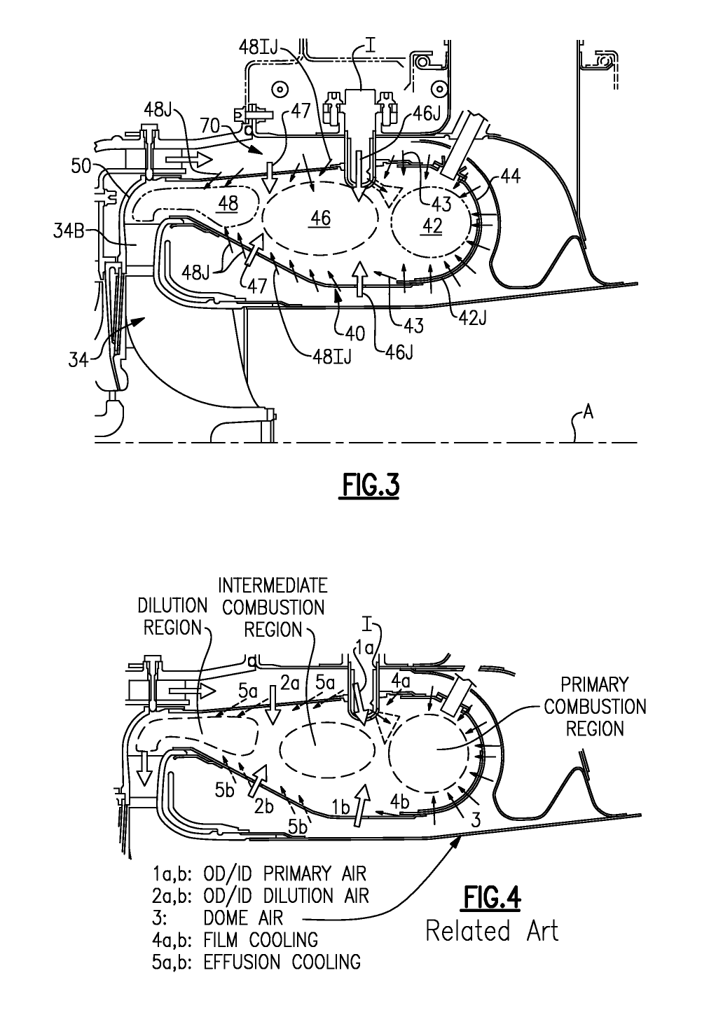

The combustor 40 takes advantage of proven design concepts for traditional liquid-fuel spray non-premixed reverse flow annular combustor designs that have a primary combustion zone located within the liner dome region (RELATED ART; FIG. 4), but employs a liner hole pattern and injector configuration which provides for a pre-vaporizing/pre-mixing type combustion process without the need for a pre-vaporizing system, such as pre-vaporizer tubes, for example. The disclosed staged combustion system and process prevents flash back, reduces complexity and cost associated with a dedicated pre-vaporizing system while preserving the potential benefits of a premixed, pre-vaporized combustion system to provide low NOx emissions, for example.

The specific injector system and liner hole size configuration identified as dilution, primary, effusion, film and dome cooling holes for the disclosed staged combustion process provides for the different method of combustion staging—pre-vaporizer/pre-mixing region 42, combustion region 46 and dilution region 48—based on a combustor cross sectional configuration originally designed to feature a non-premixed combustion sequence with a primary combustion region located within the liner dome section followed by an intermediate combustion region and a dilution region (RELATED ART; FIG. 4).

The conventional combustor (RELATED ART; FIG. 4) includes an air jet arrangement which provide air to both the primary and intermediate combustion regions in which combustion takes place on the fuel rich side in the primary zone, while the intermediate region burns significantly leaner.

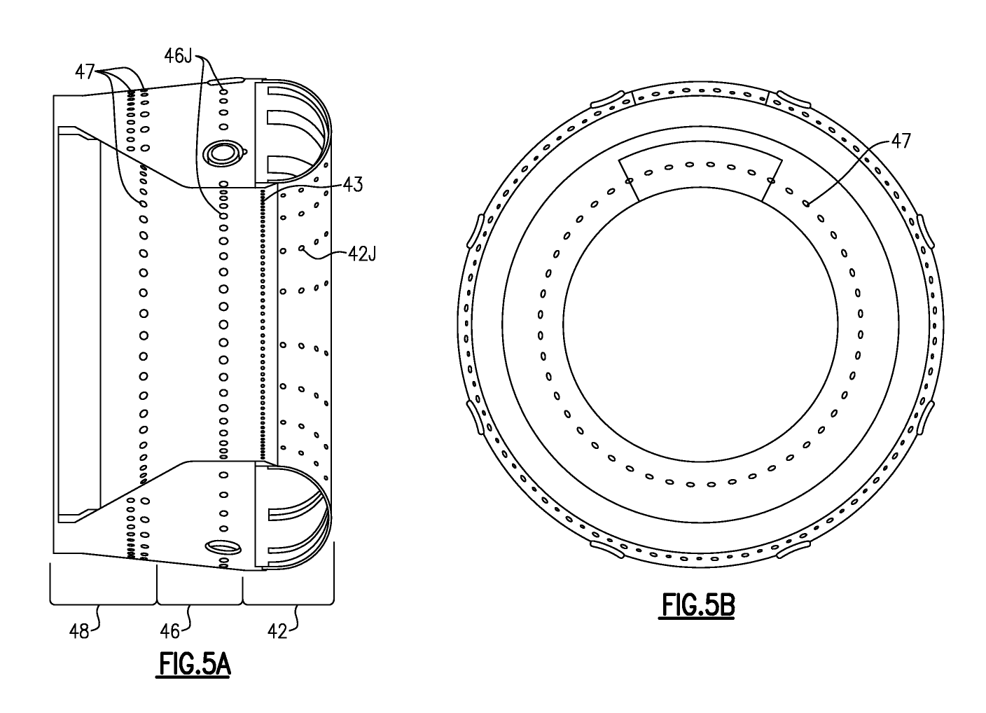

An air jet arrangement 70 disclosed herein includes pre-vaporizer/pre-mixing region jets 42J within the liner dome section 44 for the pre-vaporizer/pre-mixing region 42, primary combustion region jets 46J, film cooling jets 43 and effusion air jets 48IJ for the combustion region 46 and downstream dilution jets 47 and effusion air jets 48J for the dilution region 48 (also illustrated in FIGS. 3, 5A and 5B). In order to achieve the prescribed combustor staging, the flow split and the selected hole sizes, numbers and shapes for the air jets defined above will be a function of combustor geometric cross section (including annulus cross section), combustor inlet conditions and injector performance. Since the specific air jet arrangement flow split percentages and hole numbers, sizes and shapes (e.g., tubes, louvers) will depend on the selected combustor geometry or cross section, no specific jet arrangement and flow split need be identified herein.

The liner dome section 44 provides the function of a prevaporizer and premixing volume. While, in the present invention, the pre-vaporizer/pre-mixing jets 42J provide mixing air for the pre-mixing region 42 (FIG. 3), in the related prior art (FIG. 4), the similar jets provide film cooling at 3 and protection of the liner dome section 44 from the combustion products in the primary combustion zone (see FIG. 4). Based on the prescribed reduction of the combustion volume taken by the pre-vaporizer/pre-mixing region 42, combustion now takes place completely in the region conventionally heretofore utilized as an “intermediate combustion region” (RELATED ART; FIG. 4) with flame holding and stable combustion ensured by the prescribed mechanical or fluidic flame holders.

The dilution region 48 disclosed herein provide for enhanced dilution of the hot combustion gases to meet combustor exit flow criteria (such as maximum hot streak temperatures). Those skilled in the art of combustor design will understand that there are likely more than one dilution zone configuration (e.g., with or without transfer tubes), injector system configuration and liner hole size/number/shape configuration to the prescribed conversion from the combustion sequence (RELATED ART FIG. 4) with liner dome primary combustion zone to the sequence illustrated in FIG. 3 with the liner dome pre-vaporizer/pre-mixing region 42.

After properly designing the air jet arrangement 70 (FIG. 3), no primary air enters the liner dome section 44 as the only air which enters the liner dome section 44 is premix air. That is, the air in the liner dome section 44 is mixing air alone such that an air-fuel mixture that is fuel rich beyond a fuel rich limit so that continuous combustion cannot take place in the liner dome section 44 of the pre-vaporizer/pre-mixing region 42.

Downstream of the pre-vaporizer/pre-mixing region 42 significant dilution of the non-combusting fuel-rich mixture is provided by the primary combustion region jets 46J and effusion air jets 46IJ of the air jet arrangement 70 to form the combustion region 46 within which all the combustion takes place. That is, the primary combustion region jets 46J provide and sustain continuous combustion. While the primary function of the effusion air jets 48IJ is the protection of the combustor liner walls, they might also support the combustion process via mixing enhancement. Ignition through an igniter arrangement may be achieved in a conventional manner downstream of the liner dome section 44 and within region 42. However, in the FIG. 3 configuration, the flame will quickly transition to the intermediate zone at combustion region 46. Flame stabilization in the combustion region 46 is achieved through the suitable fuel injector arrangement I, and proper injector body design for mechanical and fluidic flame stabilization. The primary air jets 46J might also contribute to flame stabilization (so called fluidic flame stabilizers) which operate as traverse or cross-flow jets to the internal bulk flow of fuel rich gases travelling from the liner dome section 44 to the turbine nozzle 34B.

Downstream of the combustion region 46, dilution jets 48J and effusion air jets 48IJ are provided for the dilution region 48. That is, the dilution jets 47 and effusion air jets 48J (in their secondary function) provide a premixed pre-vaporized combustion system with efficient dilution so as to not damage the turbine blades 34 and turbine nozzle 34B.

It should be understood that like reference numerals identify corresponding or similar elements throughout the several drawings. It should also be understood that although a particular component arrangement is disclosed in the illustrated embodiment, other arrangements will benefit herefrom.

Although particular step sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason the appended claims should be studied to determine true scope and content.

What is claimed is:

1. A reverse flow annular combustor for a gas turbine engine comprising:
a pre-vaporizer/pre-mixing region within a liner dome section wherein fuel enters the pre-mixing/pre-vaporizing region through a fuel-injection system as a liquid fuel spray;
a combustion region downstream of said pre-vaporizer/pre-mixing region; and
a dilution region downstream of said combustion region.

2. The reverse flow annular combustor as recited in claim 1, further comprising a turn downstream of said dilution region into a turbine nozzle.

4. The reverse flow annular combustor as recited in claim 1, wherein mixing air only enters the liner dome section.

5. The reverse flow annular combustor as recited in claim 1, wherein said pre-vaporizer/pre-mixing region includes pre-vaporizer/pre-mixing region jets which provide an air-fuel mixture that is fuel rich beyond a fuel rich limit so that continuous combustion cannot take place in said liner dome section.

6. The reverse flow annular combustor as recited in claim 1, wherein said liquid-fuel injection system provides an air-fuel mixture in the prevaporizer/premixing region that is fuel rich beyond a fuel rich limit so that continuous combustion cannot take place in said liner dome section.

7. The reverse flow annular combustor as recited in claim 1, wherein said combustion region includes primary combustion region jets and a fuel injection system or fuel injector geometry which provide and sustain stable combustion.

8. The reverse flow annular combustor as recited in claim 1, wherein said combustion region includes effusion jets which provide cooling and enhanced mixing.

9. The reverse flow annular combustor as recited in claim 1, wherein said dilution region includes dilution air jets and effusion air jets.

10. The reverse flow annular combustor as recited in claim 1, wherein said pre-vaporizer/pre-mixing region includes pre-vaporizer/pre-mixing region jets provide a fuel rich mixture beyond the flammability limit, i.e., a mixture which is too fuel-rich in order to burn.

11. A method of combustion within a reverse flow annular combustor for a gas turbine engine comprising:
injecting liquid fuel into a liner dome section;
forming a pre-vaporizer/pre-mixing region within the liner dome section;
forming a combustion region downstream of the pre-vaporizer/pre-mixing region; and
forming a dilution region downstream of the combustion region.

12. The method as recited in claim 11, further comprising:
turning the combustion gases downstream of the dilution region into a radially or axially oriented turbine nozzle.

13. The method as recited in claim 12, further comprising:
communicating only mixing air into the liner dome section.

14. The method as recited in claim 12, further comprising:
communicating an air-fuel mixture that is fuel rich beyond a fuel rich limit so that continuous combustion cannot take place within the pre-vaporizer/pre-mixing region.
